(19) United States
(12) Patent Application Publication
(10) Pub. No.: US 2013/0021393 A1
(43) Pub. Date: Jan. 24, 2013

(54) STATIC ELECRONIC DISPLAY

(71) Applicants: Gregg A. Combs, Monmouth, OR (US); Cary G. Addington, Albany, OR (US)

(72) Inventors: Gregg A. Combs, Monmouth, OR (US); Cary G. Addington, Albany, OR (US)

(21) Appl. No.: 13/189,469

(22) Filed: Jul. 22, 2011

(51) Int. Cl. G09G 5/10

(52) U.S. Cl. 345/694

(57) ABSTRACT

A static electronic display employs pixels having a plurality of subpixels that exhibit one of a minimum intensity and a maximum intensity of an intensity range of the image. The static electronic display includes an array of the pixels of an electrode patterned to represent image pixels of the image. A relative number of minimum intensity subpixels and maximum intensity subpixels of each pixel in the array corresponds to an intensity level of a corresponding image pixel of the image.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Displays come in a variety of forms and provide a means of communicating information in the form of an image. For example, a display may comprise a substrate (e.g., paper or plastic film) printed with an image. Various embossed, engraved and etched substrates may also serve as displays. In other examples, the display is in the form of an electronic display device. Electronic displays include, but are not limited to, liquid crystal displays (LCDs), plasma display panels, organic light emitting diode (OLED) displays, electrophoretic (EP) displays and electrokinetic (EK) displays.

Electronic displays may provide an image either statically or dynamically. In particular, electronic displays that provide images dynamically include a means for changing the image information as a function of time. In contrast, static electronic displays are typically limited to displaying a single image. However, static electronic displays may be able to switch between a first state in which the image is not evident (i.e., a blank display) to a second state where the image is visible. Furthermore, both static and dynamic electronic displays may provide the image either in some form of a so-called black and white format that includes only intensity information or in a format that provides color information as well as intensity information.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 illustrates a schematic block diagram of a static display, according to an example of the principles described herein.

FIG. 2 illustrates a plan view of an example of a pixel of a static display having a random subpixel pattern, according to an example of the principles described herein.

FIG. 3A illustrates an example of a pixel of a static display having an arrangement of subpixels based on a spiral pattern, according to an example of the principles described herein.

FIG. 3B illustrates the pixel of FIG. 3A following selection and designation of minimum intensity subpixels, according to an example of the principles described herein.

FIG. 4A illustrates an example of a pixel of a static display having an arrangement of subpixels that are numbered based on a diagonal pattern, according to another example of the principles described herein.

FIG. 4B illustrates the pixel of FIG. 4A after selection and designation of minimum intensity subpixels, according to an example of the principles described herein.

FIG. 5A illustrates an example of a pixel of a static display having an arrangement of subpixels that are numbered based on a linear pattern, according to an example of the principles described herein.

FIG. 5B illustrates a variation on the linear pattern of FIG. 5A, according to another example of the principles described herein.

FIG. 6 illustrates an example of a pixel having subsets of subpixels, according to an example of the principles described herein.

FIG. 7 illustrates a cross-sectional view of an electronic display, according to an example of the principles described herein.

FIG. 8 illustrates a cross-sectional view of an electronic display, according to another example of the principles described herein.

FIG. 9 illustrates a flow chart of a method of displaying an image, according to an example of the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein provide a static electronic display that represents or substantially simulates an image. In particular, an intensity level associated with each image pixel of the image is converted or mapped into a pattern of subpixels within a corresponding pixel of the static electronic display, according to various examples. Once mapped, intensity levels of the individual subpixels of the subpixel pattern combine together to provide an overall intensity level of the static electronic display pixel that approximates or is substantially similar to an intensity level associated with the intensity level of the corresponding image pixel of the image. In some examples, the intensity level is related to a grayscale level while in other examples, the intensity level relates to a color channel intensity level of a color image. In some examples, the approximation provided by the subpixel pattern may substantially preserve the intensity level of the image pixel. An area in which static electronic displays are gaining popularity is as a means for realizing electronic skins (eSkins) used to personalize both electronic and non-electronic devices, for example.

According to various examples, individual subpixels within the subpixel pattern exhibit one of only two possible intensity levels, depending on a particular subpixel pattern. For example, a selected subpixel may exhibit either a minimum intensity level or a maximum intensity level of an intensity range of the image. The minimum intensity level may be black, red, blue, green, etc., for example, and the maximum intensity level may be white, clear, etc., for example, or vice versa. Since subpixels of the static electronic display exhibit only one of two intensity levels, implementations of the static electronic display may be considerably simpler than may be required when considering displaying the image directly. In particular, technologies and approaches that are only capable of displaying two intensity levels (e.g., black or white) may be employed in conjunction with the static electronic display, according to examples of the principles described herein. These same technologies and approaches may be incapable of or inappropriate for directly displaying the image, for example.

For example, the static electronic display may be an electronic display based on a technology that is inherently limited in an ability to display variations in intensity (e.g., shades of gray). Various display technologies such as, but not limited to, liquid crystal displays (LCDs), electrophoretic displays and electrokinetic displays, may exhibit such limited intensity rendering abilities in some implementations, for example. However, examples of the static electronic display according principles described herein may readily employ any of the display technologies having limited intensity rendering ability to represent the image. Moreover, examples of the static electronic display are not hindered even when a display technology is strictly limited to just two intensity levels or states since only two intensity levels are employed by the subpixels, according to various examples of the principles herein, as noted above.

Further, in some examples, the static electronic display may greatly simplify producing the image representation. For example, energizing circuitry or other means for revealing the mapped representation may be greatly simplified, according to some examples. In fact, in some examples energizing circuitry of the static electronic display may require as few as two electrical contacts (e.g., a first voltage contact and a second voltage contact). In particular, all of the subpixels of a given pixel of the static electronic display are designated to exhibit either minimum intensity subpixels or maximum intensity subpixels. As such, in a display technology in which energizing produces the minimum intensity, for example, only those subpixels that are designated to provide a minimum intensity level need be energized, according to some examples. In an alternative example, only those subpixels that are designated to provide a maximum intensity level need be energized. Moreover, if all subpixels of either the minimum intensity level or the maximum intensity level are interconnected, energizing as few as one of the subpixels through a single electrical contact (e.g., with a voltage), for example, may energize all of the subpixels of the respective intensity level to facilitate revealing the image representation. Energizing interconnected subpixels in a pixel may be provided by an electrical contact along one or more of the sides of the pixel, for example.

In some examples, the image being represented by the static electronic display is a grayscale image. By definition herein, the term ‘grayscale’ or equivalently ‘gray scale’ refers to a representation or depiction that employs only intensity variations to convey information. In particular, image information in an image is provided exclusively in terms of variations in intensity across the image. With respect to digital images, pixels that make up the digital image include or carry only intensity information. As such, a single number or value may specify information associated with each of the pixels of the digital image. Further by definition herein, ‘grayscale’ explicitly includes both black-white intensity variations and intensity variations of a monochromatic color (e.g., a single color with varying brightness). As such, grayscale images herein may include both so-called ‘black and white’ images as well as monochromatic grayscale images, by explicit definition.

The single value or number used to specify pixel information in an image is referred to as an ‘intensity level,’ by definition herein. The intensity level is a particular value or number within an ‘intensity range.’ The intensity range includes all of the possible values of the intensity level for a given image, by definition herein. In particular, the intensity range runs from a minimum intensity value to a maximum intensity value, inclusively.

For example, an image may be defined in terms of an intensity range from a minimum intensity value of zero (0) to a maximum intensity value of two hundred fifty five (255). In some examples, the minimum intensity value may represent black (e.g., 0=black) while the maximum intensity value may represent white (e.g., 255=white). For these examples, a selected pixel in the image having a intensity level equal to ninety five (95) would appear dark gray (i.e., generally more black than white) since the intensity level of ninety five (95) is closer to black (0) than white (255). Similarly, an intensity level of two hundred forty (240) would appear very light gray or almost white since the intensity level of two hundred forty (240) is closer (i.e., much closer) to white (255) than black (0). However, the designation of minimum intensity (e.g., 0) as representing black and maximum intensity (e.g., 255) as representing white is arbitrary and for discussion purposes only herein. The minimum intensity or equivalently a minimum intensity level (e.g., 0 or 1) may equally be designated to represent white and the maximum intensity or equivalently a maximum intensity level (e.g., 255 or 256) may equally be designated to represent black, for example. Note that while ‘white’ may be used herein as an example of either a maximum intensity or a minimum intensity depending on how the intensity range is defined, the intensity level referred to as ‘white’ herein may also represent substantially no color (e.g., clear for a transmissive display), in some examples.

In other examples, such as for a monochromatic grayscale image, the maximum intensity may represent a particular color that is fully saturated while the minimum intensity represents completely unsaturated color, or vice versa. In still other examples, the intensity range may include a range of intensity variations that is less than a total range of possible intensity variations. For example, the intensity range may run from dark gray to light gray. Dark gray may represent the minimum intensity level and light gray may represent the maximum intensity level, for example. In another example, the intensity range of the monochromatic gray scale image may run from dark blue to light blue, where dark blue represents the minimum intensity level and light blue may represent the maximum intensity level, for example.

Still further herein, images displayed by the static electronic display described herein are distinct from images displayed by electronic displays that provide so-called ‘binary images’ such as, but not limited to, 1-bit images, halftone images and duotone images. In particular, by definition herein, all images comprise intensity ranges that explicitly include more than two intensity levels. As such, any image having image pixels that employ or require more than a 1-bit binary value (i.e., more than ‘0’ or ‘1’) to specify the intensity information carried by the image pixels is generally an ‘image’, by the definition herein. On the other hand, if one bit is sufficient (e.g., as with a halftone image) to specify the image pixel intensity information, then that image is not an image, according to the definition provided herein.

In other examples, the image that is represented by the static electronic display is a color image. In some examples, the color image is mapped into a grayscale image and the static electronic display represents the grayscale image, after mapping. In other examples, the static electronic display directly represents the color image without a grayscale mapping. In examples in which the static electronic display directly represents the color image, the subpixels may be divided into a plurality of subsets of subpixels, one subset for each of a primary color or a color channel in the color image. For example, a first subset may represent red, a second subset may represent green and a third subset may represent blue. Subsets representing red, green and blue may be used when the color image is based on a red-green-blue (RGB) color model, for example. In another example, such as when the color image is based on a cyan-yellow-magenta-key (CYMK) color model, the subsets of the subpixels may be dedicated to representing each of cyan, yellow, magenta and the key (e.g., black) colors.

When representing a color image, each of the subsets of the subpixels comprise subpixels that still exhibit only one of two possible intensity levels. However the intensity levels and the intensity range for a given color channel are dependent on the color of that channel. For example, subpixels in a red subset may take on or exhibit either fully saturated red and fully unsaturated red (e.g., white or clear). Fully saturated red may represent a minimum intensity level and fully unsaturated red may represent a maximum intensity level for the intensity range for the red channel of the color image, for example (the converse may also be used). Similarly, subpixels in a blue subset may exhibit one of fully saturated blue (e.g., minimum intensity blue) and fully unsaturated blue (e.g., maximum intensity blue), for example (moreover, the converse may also be used). For simplicity of discussion herein only, explicit reference to subsets of subpixels within a pixel is generally omitted unless necessary for proper understanding. Furthermore, discussion below that deals with subpixels specifically of a single type or subset may be readily extended to a plurality of subsets of subpixels.

Herein, ‘static’ when applied to a display is defined as a display that represents a fixed or a constant image. For example, the static image may be predefined during formation of the static display. An image printed on a paper substrate is a static image once the image is printed, for example. Similarly, an electronic display that either displays a predefined image or is blank (e.g., all white or all black) depending on whether or not the electronic display is energized is considered a static electronic display, by definition herein.

A plurality of static images may be combined to form what appears to be a moving or changing image, however. For example, motion pictures typically employ a sequence of static images or frames to depict or simulate a moving image. Similarly, neon signs often use multiple, static images to depict or simulate motion (e.g., a bird that is flapping its wings). As such, the definition of a ‘static electronic display’ explicitly includes an electronic display having the capability of displaying more than one static image. For example, the static electronic display may be capable of sequentially display a plurality of static images to simulate a moving image in a manner analogous to the techniques mentioned above with respect to motion pictures and neon signs. The multiple static images may be implemented as multiple states of the static electronic display, for example.

Further, as used herein, the article ‘a’ is intended to have its ordinary meaning in the patent arts, namely ‘one or more’. For example, ‘a subpixel’ means one or more subpixels and as such, ‘the subpixel’ means ‘the subpixel(s)’ herein. Also, any reference herein to ‘top’, ‘bottom’, ‘upper’, ‘lower’, ‘up’, ‘down’, ‘front’, back’, ‘left’ or ‘right’ is not intended to be a limitation herein. Herein, the term ‘about’ when applied to a value generally means plus or minus 10% or within normal tolerances of a measurement technique used, unless otherwise expressly specified. The term ‘substantially’ as used herein means a majority, or almost all, or all, or an amount with a range of about 51% to 100%, for example. Moreover, examples herein are intended to be illustrative only and are presented for discussion purposes and not by way of limitation.

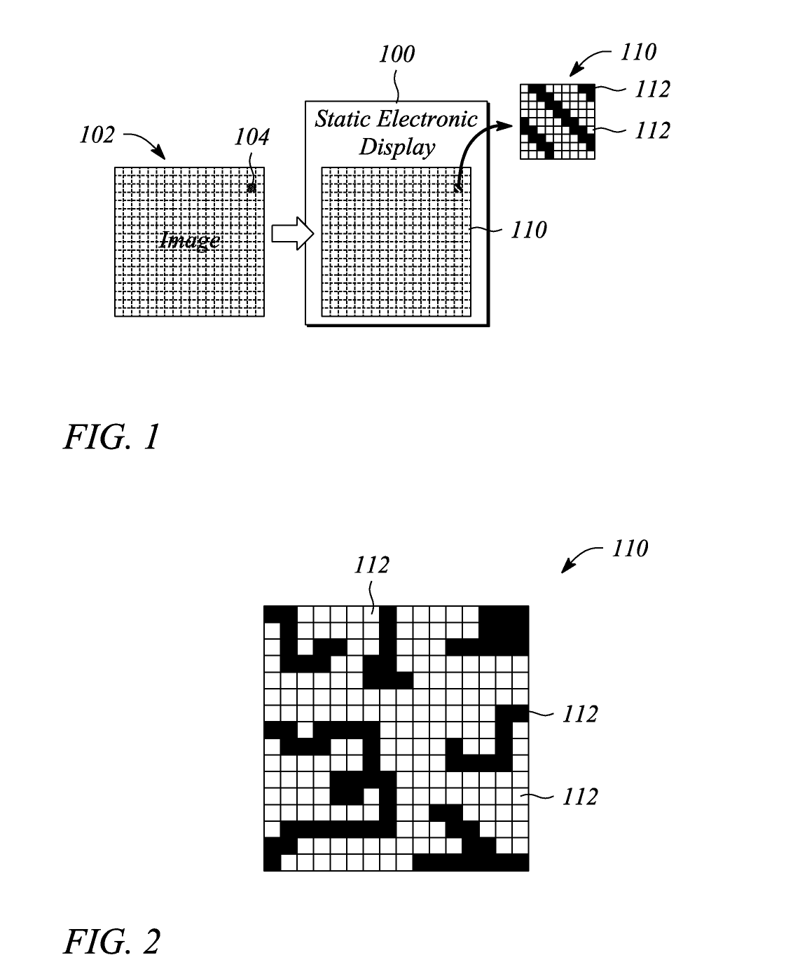

FIG. 1 illustrates a schematic block diagram of a static electronic display 100, according to an example of the principles described herein. In particular, the static electronic display 100 represents an image 102 and may be implemented as a mapping from image pixels 104 of the image 102 to corresponding pixels in the static electronic display 100. In some examples, the mapping correspondence is a one-to-one correspondence. The pixels 110 of the static electronic display 100 provide an approximation of an intensity level of the corresponding image pixels 104. According to some examples, the intensity level may represent a grayscale level of a grayscale image 102 while in other examples the intensity level is associated with a color channel of a color image 102. As illustrated in FIG. 1, a large arrow denotes the mapping from a collection of the image pixels 104 of the image 102 to corresponding pixels 110 of the static electronic display 100.

In some examples, the representation of the image 102 is provided or made evident by the static electronic display 100 only when the static electronic display 100 is energized. For example, the static electronic display 100 may be substantially blank (e.g., entirely white, entirely black, transparent, solidly one color, etc.) until it is energized. When energized, the static electronic display 100 may transition from a first state that is substantially blank to a second state in which the representation of the image 102 is evident, for example. In some examples, when the static electronic display 100 is de-energized, the static electronic display transitions back to the first state. In other examples, the static electronic display 100 may be momentarily energized to reveal the representation of the image 102. The momentary energizing of the static electronic display 100 may be used to cause the static electronic display 100 to toggle ON and then OFF, for example. According to various examples, the static electronic display may be energized by a voltage, a current or another energy source that is applied to the static electronic display.

Examples in which the image 102 representation is made evident by energizing the static electronic display 100 include when the static electronic display 100 is implemented using any one of several electronic display technologies that may be energized by the application of a voltage, a current, or another energy source that is applied to the static electronic display, for example. Example electronic display technologies include, but are not limited to, liquid crystal displays (LCD), electrophoretic (EP) displays and various electrokinetic (EK) display technologies. For example, an electrophoretic display may be energized using a first voltage to cause a transition from the first state to the second state to reveal the image representation. A second voltage may be used return the electrophoretic display to the first state in which the static electronic display 100 is substantially blank, for example.

The static electronic display 100 comprises an array of pixels (or ‘display pixels’) 110 of an electrode. The array of pixels 110 of the electrode is patterned to represent image pixels 104 of the image 102. In some examples, each pixel 110 of the array corresponds to an image pixel or pixels 104 in the image 102. For example, a number of pixels 110 in the array is substantially similar to and may even equal a number of image pixels 104 in the image 102. In some examples, an aspect ratio of the array of pixels 110 (e.g., a number of rows to a number of columns) is substantially similar to an aspect ratio of the image pixels 104. In particular, the array of pixels 110 may substantially represent a one-to-one mapping of the image pixels 104 of the image 102, in some examples. For example, there may be both equality between a number of image pixels 104 and a number of pixels 110 in the array and a correspondence in a relative location of the pixels 110 in the array and the image pixels 104 in the image 102.

In various examples herein, each pixel 110 of the array comprises a plurality of subpixels 112. According to some examples, a number of subpixels 112 in each pixel 110 is greater than two. In some examples, a number of subpixels 112 in each pixel 110 may be greater than three, or greater than four, or greater than five. In yet other examples, the number or quantity of subpixels 112 in pixels 110 is similar or related to a number of intensity levels in an intensity range of the image 102. For example, the number of subpixels 112 may be about one half (½) of the number of intensity levels. In another example, the number of subpixels 112 may be about 60-90% of the number of intensity levels. In another example, the number of subpixels 112 may be the number of intensity levels minus a quantity. For example, the number of subpixels 112 may be equal to the number of intensity levels minus one (1), minus five (5), or minus ten (10). In yet other examples, there may be more subpixels 112 than there are intensity levels in the image 102. For example, the number of subpixels may be one hundred ten percent (110%) of the number of intensity levels.

According to some examples, the number of subpixels 112 in each pixel 110 is equal to an integer multiple of a total number of intensity levels of an intensity range of the image 102. For example, if the image 102 has an intensity range from zero to two hundred fifty five (0-255), the total number of intensity levels equals 256, and each pixel 110 may have two hundred fifty six (256) subpixels 112. In another example, there may be two hundred fifty six (256) intensity levels in the image 102 and each pixel 110 may comprise an integer multiple of 4, or one thousand twenty four (1024), subpixels 112 (i.e., 4×256=1024). In another example, the image 102 may have sixteen (16) intensity levels (e.g., an intensity range from 0 to 15) and the pixels 110 may have an integer multiple of 2, or thirty two (32) subpixels 112 (i.e., 2×16=32). In yet another example, the image 102 may have an intensity range from zero to five hundred eleven (511) for a total of five hundred twelve (512) intensity levels. Each pixel 110 may comprise one of five hundred twelve (512) subpixels 112 (an integer multiple of 1), one thousand twenty four (1024) subpixels 112 (an integer multiple of 2), and two thousand forty eight (2048) subpixels 112 (an integer multiple of 4), for such an example. In yet another example, the image 102 may comprise one hundred intensity levels (e.g., a intensity range from 1 to 100) such as when grayscale is determined as a percentage of white relative to black. In such examples, the pixels 110 may comprise subpixels 112 numbering an integer multiple (1, 2, 3, etc.) of one hundred (e.g., 100, 200, 300, and so on).

According to some examples, each subpixel 112 in the plurality is configured to exhibit one of a minimum intensity and a maximum intensity of the intensity range. For example, the minimum intensity may be black and the maximum intensity may be white (or clear). Hence, each subpixel 112 may be either black or white (or clear). In another example, the minimum intensity may be dark gray and the maximum intensity may be light gray, and each subpixel 112 is either dark gray or light gray, for example. In another example, the minimum intensity may be dark green and the maximum intensity may be light green, and each subpixel 112 is either dark green or light green, for example. In another example, the minimum intensity may be a dark color (e.g., red, green or blue) and the maximum intensity may be white or clear, for example.

According to various examples, a relative number of the minimum intensity subpixels 112 and the maximum intensity subpixels 112 of each pixel 110 in the array corresponds to an intensity level of a corresponding image pixel 104 of the image 102. In particular, a correspondence may be established between an intensity level and the relative number of minimum intensity and maximum intensity subpixels 112 according to an approximation of the intensity level realized by the combined subpixels 112. The approximation may be an average intensity provided by the combined subpixels 112, in some examples. In other examples, the approximation may be according to a linear relationship between a number of the minimum intensity or maximum intensity subpixels and the intensity level. In yet other examples, a nonlinear relationship (e.g., an S-curve, logarithmic relationship, etc.) approximation may be employed. Further, in some examples, all of the subpixels are substantially uniform in one or both of size and shape while in other examples the subpixels are non-uniform in one or both of size and shape.

For example, when the intensity range begins at a numerical value of zero corresponding to the minimum intensity, the approximation may be provided by a number of maximum (or minimum) intensity subpixels 112 in a pixel 110 that is equal to a numerical value of the intensity level of the corresponding image pixel 104. For an intensity range of from zero to two hundred fifty five (i.e., 0-255), a intensity level of the image pixel 104 having a value of one hundred forty two (142) may be represented by one hundred forty three (143) white subpixels 112 and one hundred thirteen (113) black subpixels 112 within the corresponding pixel 110 of the display 100, for example. In another example, an intensity level of seventy five (75) may be represented by seventy five (75) white subpixels 112. When the intensity range is from zero to 100, a balance of the subpixels 112 (e.g., 25) may be black, for this example.

According to some examples, the subpixels 112 in the plurality may be divided into subsets of subpixels. For example, each subset of subpixels 112 may be assigned or designated to represent a different one of a plurality of primary colors. The maximum or minimum intensity exhibited by each of the subpixels 112 in a given subset may be one of a maximum intensity and a minimum intensity for the represented primary color of the given subset, for example. The relative number of subpixels 112 exhibiting the minimum intensity and the maximum intensity of the primary color for the given subset may be determined by an intensity level of the equivalent color channel of a corresponding image pixel 104 of the image 102, for example.

In some examples of the static electronic display 100, there is or there exists an unbroken path or electrical connection from each minimum intensity subpixel 112 in a respective pixel 110 to an edge of the respective pixel 110. In other examples, there is or there exists an unbroken path or electrical connection from each maximum intensity subpixel 112 in a respective pixel 110 to an edge of the respective pixel 110. For either of the minimum intensity or maximum intensity examples, the unbroken path or electrical connection may be one or both of a direct connection from the subpixel 112 to the edge for subpixels 112 that are adjacent to the edge and an unbroken path through contiguous like-intensity subpixels 112 of the respective pixel 110, according to various examples. In other words, each respective minimum intensity or maximum intensity subpixel 112 (i.e., whether black, white or other color) is connected to an edge of the pixel 110 either directly or through at least one other respective minimum or maximum intensity subpixel 112. In these examples, no respective intensity subpixel 112, or interconnected set thereof, is completely surrounded by the other respective intensity subpixels 112. As such, respective subpixels 112 of either minimum intensity or maximum intensity do not form island(s) within the respective pixel 110. The unbroken path may be provided by connections at adjacent sides of contiguous adjacent respective intensity subpixels 112, according to some examples. In other examples, the unbroken path may also include respective intensity subpixels 112 that touch one another only at one or more of corners and along sub-portions of the adjacent sides. The unbroken path may facilitate energizing the respective intensity subpixels 112 through an electrical connection at or along the edge of the pixel 110, for example.

In some examples where subsets of subpixels 112 are present to represent colors, the unbroken path may pass through all minimum intensity (or maximum intensity) subpixels 112 regardless of subset. In other examples, a plurality of unbroken paths is provided such that each subset has a dedicated separate unbroken path. In yet other examples, one or more subsets of subpixels 112 may share an unbroken path while another one of the subsets has a dedicated separate unbroken path.

According to various examples of the principles described herein, subpixels 112 may be organized or arranged in any number of patterns. FIG. 2 illustrates a plan view of an example of a pixel 110 of a static electronic display 100 having a random subpixel pattern, according to an example of the principles described herein. In particular, a pattern or specific locations of the minimum intensity subpixels 112 and the maximum intensity subpixels 112 illustrated in FIG. 2 is substantially random while contiguous ones of respective intensity subpixels 112 extend to an edge of the pixel 110, as illustrated in FIG. 2.

For example, subpixels 112 may be selected and designated as minimum intensity subpixels using a random or pseudorandom process such as a Monte Carlo selection or using a Genetic Algorithm, for example. The random selection may continue until a number of minimum intensity subpixels is equal to the intensity level of the corresponding image pixel 104, for example. Alternatively, the random selection may continue until an average intensity of the pixel 110 approximates the corresponding image pixel 104 intensity level.

In some examples, where an unbroken path is targeted, a constrained random selection may be employed. The random selection and designation of minimum intensity (or maximum intensity) subpixels may be constrained to insure that at least one aforementioned unbroken path to the pixel edge 110 exists from all minimum intensity (or maximum intensity) subpixels selected during the random selection, for example. For example, the random selection and designation may be constrained according to an underlying non-random pattern (e.g., a spiral pattern, a diagonal pattern, a checkerboard pattern, etc.) that insures the unbroken path. Alternatively, the constraint may be imposed as a test during random selection and designation, for example. In some examples, random selection and designation may be employed to produce a lookup table of random patterns. The lookup table may then be used to establish the subpixel pattern for a given pixel, for example.

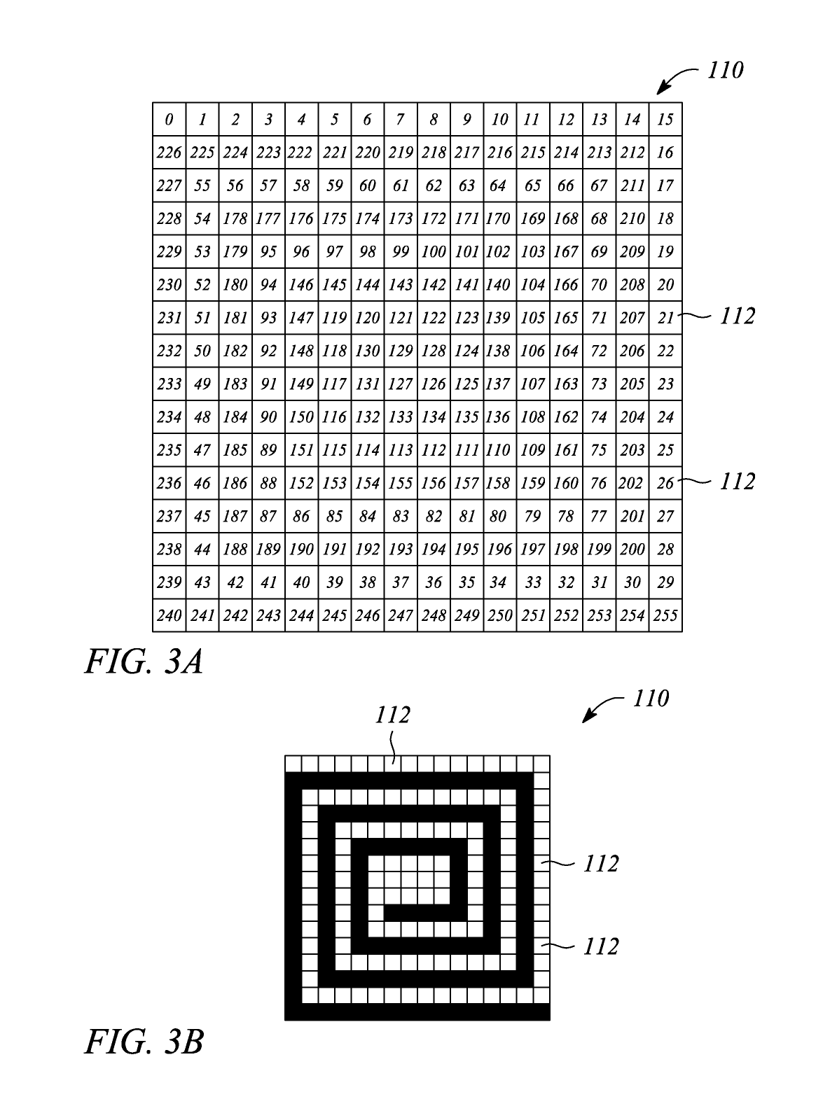

FIG. 3A illustrates an example of a pixel 110 of a static electronic display 100 having an arrangement of subpixels 112 based on a spiral pattern, according to an example of the principles described herein. In particular, the subpixels 112 illustrated in FIG. 3A are numbered in a spiral pattern. Using the numbering, a contiguous set of subpixels 112 corresponding to an intensity level of the corresponding image pixel 104 may be selected and designated, for example, as maximum intensity subpixels 112. For example, if the intensity level is one hundred thirty two (132) in a intensity range starting at zero, then subpixels 112 numbered zero (0) through one hundred thirty one (131) may be selected and designated as maximum intensity subpixels 112. All non-selected subpixels 112 are designated as minimum intensity subpixels 112 in this example. FIG. 3B illustrates the pixel 110 of FIG. 3A following selection and designation of maximum intensity subpixels 112, according to an example of the principles described herein. As illustrated, the selected and designated maximum intensity subpixels 112 along with the unselected minimum intensity subpixels 112 (i.e., depicted as black squares in FIG. 3B, by way of example) form a spiral pattern due to the aforementioned subpixel numbering. Note that FIGS. 3A and 3B illustrate a double spiral pattern. Other spiral patterns including, but not limited to, single, triple and quadruple spirals also may be employed. Also, multiple spirals in which different ones of the spirals correspond to different separate subsets of subpixels 112 representing different primary colors (e.g., R, G or B) may be employed, for example.

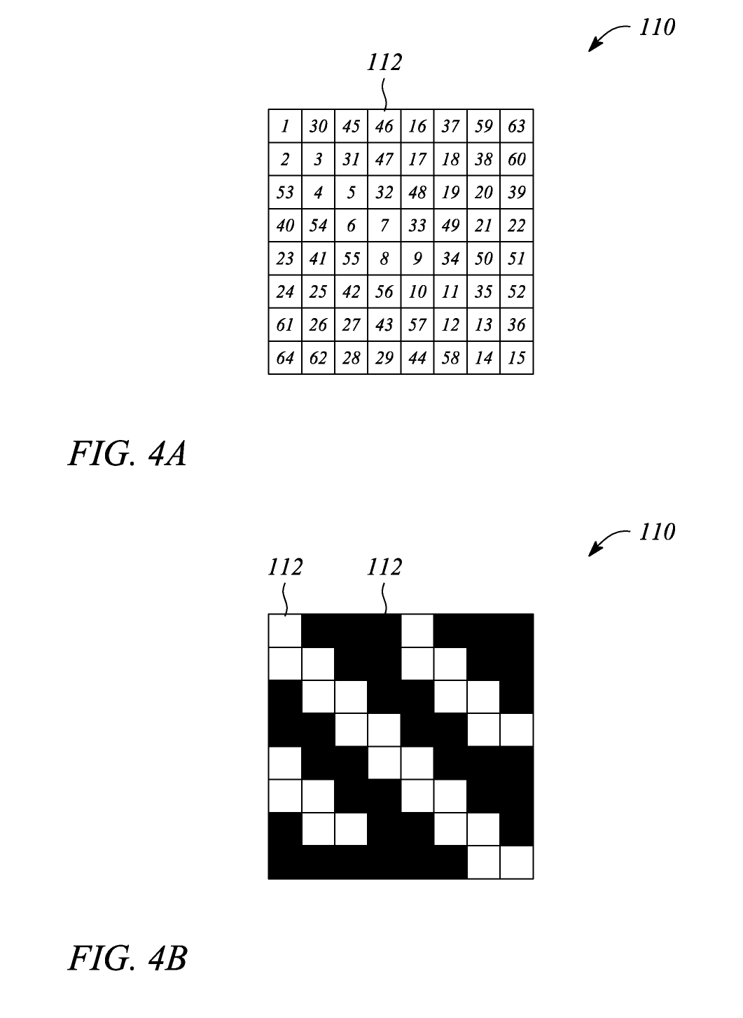

FIG. 4A illustrates an example of a static electronic display pixel 110 having subpixels 112 that are numbered based on a diagonal pattern, according to another example of the principles described herein. As above, a contiguous set of subpixels 112 corresponding to a intensity level of a corresponding image pixel 104 may be selected and designated, for example, as maximum intensity subpixels 112, according to the numbering. For example as illustrated, the intensity range may be from one to sixty four (1-64) and the intensity level of the corresponding image pixel 104 may be twenty seven (27). Subpixels 112 numbered one (1) through twenty seven (27) are then selected and designated as maximum intensity subpixels 112 in this example. Moreover in this example, all non-selected subpixels 112 are designated as minimum intensity subpixels 112. FIG. 4B illustrates the pixel 110 of FIG. 4A after selection and designation of maximum intensity subpixels 112, according to an example of the principles described herein. As illustrated, the selected and designated maximum intensity subpixels 112 along with the unselected minimum intensity subpixels 112 form an arrangement based on a diagonal pattern due to the subpixel numbering of FIG. 4A.

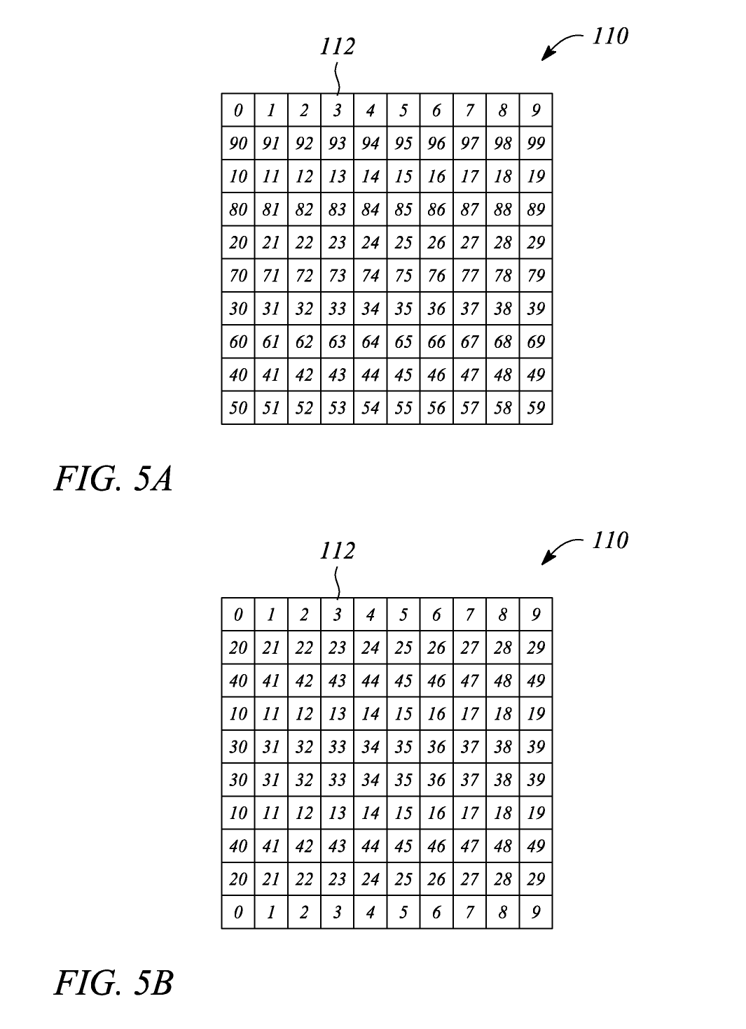

FIG. 5A illustrates an example of a pixel 110 having subpixels 112 that are numbered based on a linear pattern, according to an example of the principles described herein. Subpixels 112 are numbered along rows in FIG. 5A and form one or more lines of maximum intensity subpixels 112 when selected and designated, for example. FIG. 5B illustrates a variation on the linear pattern of FIG. 5A, according to another example of the principles described herein. In particular, the linear pattern of FIG. 5B employs a number of subpixels (e.g., 100) that is an integer multiple of two (2) times the number of intensity levels (e.g., 50). As such, for each intensity level, there are two identically numbered subpixels 112 as illustrated. The identically numbered subpixels 112 may be selected and designated simultaneously to determine the subpixel pattern based on the intensity level of the corresponding image pixel 104, for example.

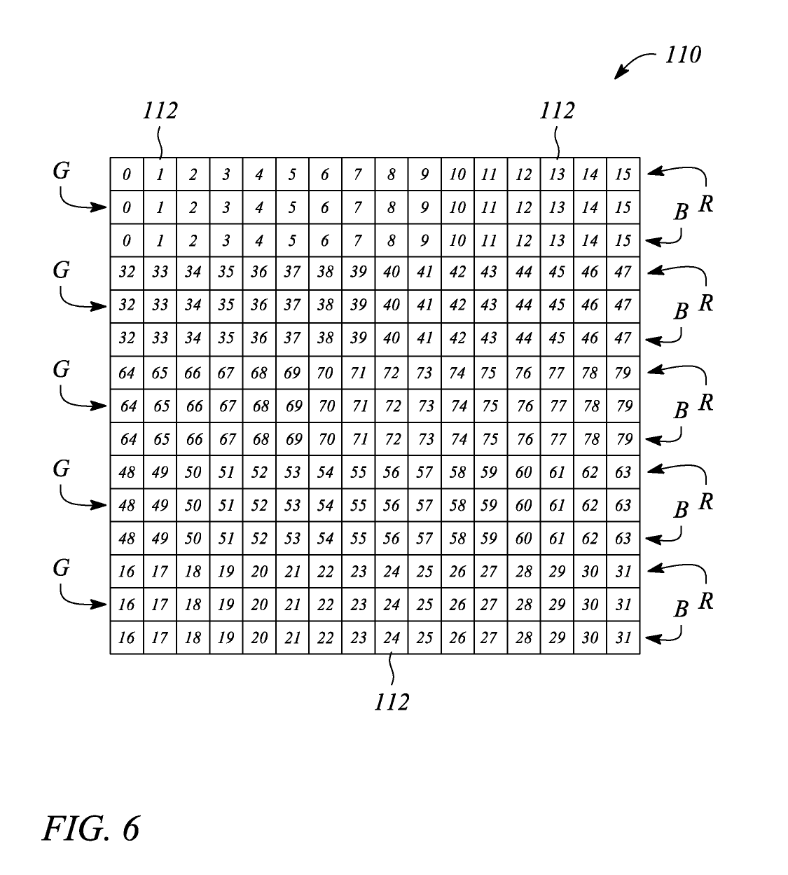

FIG. 6 illustrates an example of a pixel 110 having subsets of subpixels 112, according to an example of the principles described herein. As illustrated, the subsets of subpixels 112 are numbered based on a linear pattern. In particular, subpixels 112 of different subsets are numbered along interleaved rows in FIG. 6 and form one or more lines of maximum intensity subpixels 112 for each subset when selected and designated, for example. Each subset may represent a different primary color of a specific color model (e.g., RGB, CYMK, etc.), for example. For example, numbered subpixels 112 in rows labeled R may correspond to subpixels 112 that exhibit either minimum intensity or maximum intensity for a primary color of red. Similarly, numbered subpixels 112 in rows labeled G and B, respectively, correspond to subpixels 112 that exhibit either a minimum intensity or a maximum intensity for primary colors green and blue, respectively.

Various other patterns (e.g., checkerboards, cross patterns, etc.) beyond those described above may be devised using the spiral pattern, the diagonal pattern and the various other previously described patterns as examples. Furthermore herein, the particular patterns of subpixels 112 described above are provided by way of example and not limitation. Moreover, while described herein as selecting and designating maximum intensity subpixels 112, alternatively minimum intensity subpixels 112 may be selected and designated without departing from the scope of the principles described herein.

In some examples, the array of pixels 110 of the electrode is an array of regions, each region representing one of the pixels 110 of the array. In various examples, each region is further subdivided into sub-regions representing the subpixels 112. In some examples, the patterned electrode having the array of regions may be one or both of a front electrode and a back electrode of an electronic display. For example, the electronic display may be an electrophoretic display and the patterned electrode may comprise a patterned conductor of a front electrode, a back electrode or a combination of the front and back electrodes. In another example, the electronic display may be an electrokinetic display and the patterned electrode (e.g., a front electrode, a back electrode or both) may comprise one or both of a patterned conductor and a patterned dielectric layer overlying a conductor. In yet another example, the array of regions may comprise patterned conductor layer(s) of one or both of a front electrode and a back electrode of a liquid crystal display. In various other examples, the electronic display may be any of a variety of other types of displays that employ one or both of a front electrode and a back electrode and include some form of patterning to define regions and sub-regions.

In particular, according to some examples, the patterned electrode comprises a conductor patterned within the region of each pixel 110 to provide sub-regions corresponding to a first set of subpixels 112 in which the conductor is absent and further to provide other sub-regions corresponding to a second set of subpixels 112 in which the conductor is present. The first set may represent one of the maximum intensity subpixels 112 and the minimum intensity subpixels 112, and the second set represents the other one thereof, according to some examples. In some examples, each of the conductor-present sub-regions is either directly or indirectly electrically connected to an edge of the region of the electrode representing the pixel. The indirect electrical connection may be through adjacent conductor-present subpixels, for example. The conductor may be either a transparent conductor on a front electrode, for example, or a substantially non-transparent conductor (e.g., a metal film) on a back electrode, for example.

Further according to some examples, the patterned electrode comprises a conductor covered by a patterned dielectric layer that is patterned to provide both sub-regions corresponding to a first set of subpixels 112 and sub-regions corresponding to a second set of subpixels 112. The dielectric layer may be absent to substantially expose the conductor in sub-regions corresponding to the first set while the dielectric layer may be present in sub-regions corresponding to the second set. In some examples, the first set may represent the minimum intensity subpixels 112 while in other examples the first set may represent the maximum intensity subpixels 112 of the pixel 110.

In some examples, a common connection (e.g., an electrical connection) may be provided from edges of the pixels 110 to an edge of the electrode. For example, each pixel 110 in the array may be surrounded by a conductor that connects to the edge of the electrode. In another example, only one, two or three edges of each pixel 110 are connected to the edge of the electrode by the common connection. For example, the conductor may be only along one, two or three of the edges of the pixel 112 and not all four edges.

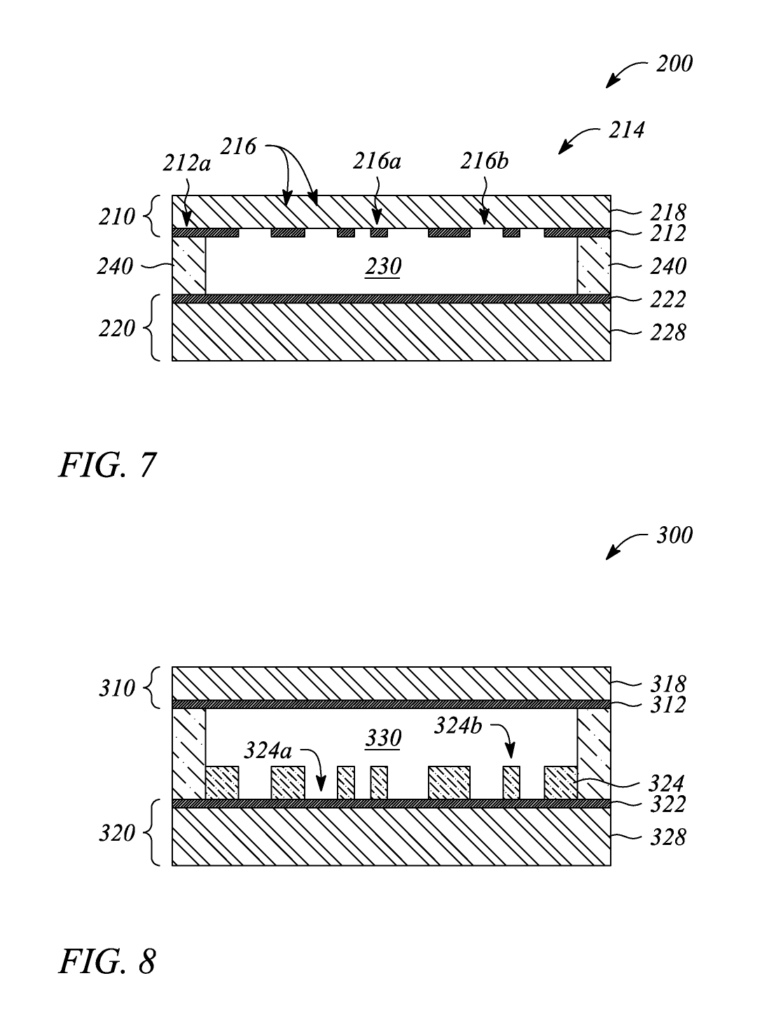

FIG. 7 illustrates a cross-sectional view of an electronic display 200, according to an example of the principles described herein. In particular, a region 214 that defines a pixel of the electronic display 200 is illustrated. The electronic display 200 comprises a first or front electrode 210. The front electrode 210 comprises a film or layer of a conductor 212. The conductor 212 may comprise a substantially transparent conductor such as, but not limited to, indium tin oxide (ITO), fluorine doped tin oxide (FTO), doped zinc oxide, various other transparent conductive oxides, conductive polymers (e.g., poly 3,4-ethylenedioxythiophene (PEDOT)) and polystyrene sulfonate doped PEDOT), nano-silver coatings and nano-carbon coatings (e.g., graphene and various carbon nanotube based networks), for example. The electronic display 200 may be one layer of a multiple layer (e.g., a stacked) display according to some examples.

The conductor 212 is patterned within the region 214 that defines the pixel to provide sub-regions 216 corresponding to subpixels. According to some examples, the pixel and the subpixels may be substantially similar to the pixel(s) 110 and the subpixels 112, respectively, described above for the static electronic display 100. In some examples, the conductor 212 may be present in sub-regions 216a corresponding to a first set of subpixels and absent in sub-regions 216b corresponding to a second set of subpixels. The first set of subpixels may be one of maximum intensity subpixels and minimum intensity subpixels, for example, and the second set of subpixels is the other one thereof. A portion of the conductor 212a near an edge of the region 214 that defines the pixel may provide a common connection from the pixel to an edge of the electrode 210, for example.

In some examples, all of the sub-regions 216a in which the conductor 212 is present are electrically connected to an edge of the region 214 of the front electrode 210 representing the pixel. Electrically connecting all of the sub-regions 216a with conductor 212 to the edge of the pixel-defined region 214 of the front electrode 210 may facilitate energizing the conductor 212, for example. For example, the edges of each pixel-defined region 214 may be ringed with or surrounded by the conductor portion 212a that is, in turn, connected to an edge of the front electrode 210. A voltage or a current may be applied to each of sub-regions 216a by applying the voltage or current to a contact at the edge of the front electrode 210 to energize the conductor 212, for example.

The front electrode 210 further comprises a transparent or substantially transparent substrate 218. For example, the transparent substrate 218 may comprise, but is not limited to, a sheet or film of glass, plastic or a related transparent polymer. The conductor 212 may be deposited on the transparent substrate 218 and then patterned by selectively removing portions of the conductor 212 from the sub-regions 216b in which the conductor is absent, for example. In another example, the conductor 212 may be selectively deposited only on the sub-regions 216a leaving the sub-regions 216b without conductor 212.

For example, patterning may be provided by laser ablation of the conductor 212 (e.g., in layer form), for example. In other examples, selective etching may be used to pattern the conductor 212. In yet other examples, the conductor 212 may be printed in the pattern that defines the sub-regions 216. Printing may be provided using any of a number of printing methodologies including, but not limited to, an inkjet printing and using nanoimprint lithography, for example. Any of a variety of other techniques used in circuit manufacture may also be used (e.g., lift-off, selective deposition, etc.) to provide patterning of the conductor 212, for example.

As illustrated in FIG. 7, the electronic display 200 further comprises a second or back electrode 220. The back electrode 220 may comprise a conductor 222 on a substrate 228. The conductor 222 may be substantially similar to the conductor 212 described above, for example. In some examples, the back electrode 220 is transparent or substantially transparent while in other examples the back electrode 220 is substantially opaque and even may be substantially reflective. The conductor 222 may be a substantially continuous film or layer, according to some examples. In other examples, the conductor 222 may be patterned (not illustrated). When patterned, the patterning of the conductor 222 may correspond to the patterning of the conductor 212 of the front electrode 210, for example.

The electronic display 200 may further comprise a display medium 230 disposed between the front and back electrodes 210, 220, according to some examples. For example, such as when the electronic display 200 is an electrophoretic or an electrokinetic display, the display medium 230 may comprise colorant particles suspended in a carrier solution. In another example, the display medium 230 may comprise a liquid crystal material. In various examples, the display medium 230 may be partially or completely confined to a vicinity of the pixel defined by region 214, for example, by walls 240. In particular, the walls 240 may substantially separate the display medium 230 from the display medium of adjacent pixels (not illustrated).

FIG. 8 illustrates a cross-sectional view of an electronic display 300, according to another example of the principles described herein. As illustrated, the electronic display 300 comprises a first or front electrode 310, a second or back electrode 320 and a display medium 330 disposed therebetween. The front electrode 310 comprises a conductor 312 and a substrate 318. In some examples, the conductor 312 and the substrate 318 are substantially similar to the conductor 212 and substrate 218 of the front electrode 210, described above with respect to the electronic display 200. However, the conductor 312 may be substantially continuous (e.g., a film or a layer) as illustrated in FIG. 8, as opposed to being patterned as described above for the electronic display 200. Similarly, the display medium 330 may be substantially similar to the display medium 230, described above with respect to the electronic display 200.

As illustrated in FIG. 8, the back electrode 320 of the electronic display 300 comprises a conductor 322 and a substrate 328. The conductor 322 and the substrate 328 may be substantially similar to the conductor 222 and the substrate 228 described above with respect to the back electrode 220 of the electronic display 200, according to some examples. The back electrode 320 further comprises a dielectric layer 324 adjacent to the conductor 322. The dielectric layer 324 is patterned to provide sub-regions 324a corresponding to a first set of subpixels in which the dielectric layer 324 is absent to expose the conductor 322. The dielectric layer 324 is further patterned to provide sub-regions 324b corresponding to a second set of subpixels in which the dielectric layer is present. The subpixels of the first and second sets may be substantially similar to subpixels 112 described above with respect to the static electronic display 100, according to some examples. In particular, the first set may represent one of minimum intensity subpixels and maximum intensity subpixels of the electronic display 300, for example, and the second set represents the other one thereof.

When the electrodes 310, 320 are energized, the sub-regions 324a of the patterned dielectric layer 324 may allow colorant particles to accumulate adjacent to the exposed conductor 322 to display the minimum (or maximum) intensity subpixels 112, for example. Sub-regions 324b where the dielectric layer 324 is present may not allow the accumulation of colorant particles and therefore may serve as maximum (or minimum, i.e., the other) intensity subpixels, for example. The above-described accumulation and non-accumulation of colorant particles is characteristic of an electrokinetic display, for example.

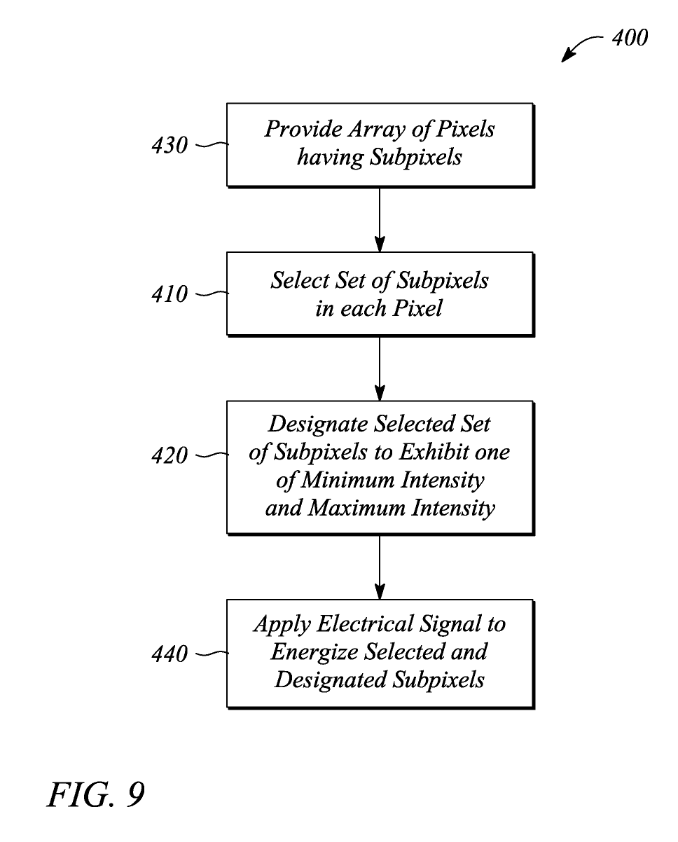

FIG. 9 illustrates a flow chart of a method 400 of displaying an image, according to an example of the principles described herein. The method 400 of displaying an image comprises selecting 410 a set of subpixels from a plurality of subpixels in each pixel of an array of pixels. The pixels in the array are configured to represent image pixels of an image, according to various examples. A quantity of subpixels in the selected set of each pixel corresponds to an intensity level of a corresponding image pixel of the image. In particular, the intensity level determines how many of subpixels are selected, according to some examples. For example, the quantity of subpixels selected may be equal to the intensity level. In some examples, the quantity of subpixels in the selected set is an integer multiple of the intensity level. In some examples, selecting 410 the set follows one of a spiral pattern, a diagonal pattern, a linear pattern and a checkerboard pattern. In other examples, selecting 410 the set is performed according to a random process. In some examples, selecting 410 the set is performed to insure that all subpixels in the set are connected either directly or through adjacent selected subpixels to an edge of the pixel.

The method 400 of displaying an image further comprises designating 420 the subpixels of the selected set to exhibit one of a minimum intensity and a maximum intensity of the intensity range of the image. In other words, in some examples, the subpixels of the selected set are designated 420 to be minimum intensity subpixels. Remaining subpixels of the plurality that are not selected in each pixel exhibit the other intensity, e.g., the maximum intensity of the intensity range.

In some examples, the method 400 of displaying an image optionally comprises providing 430 the array of pixels to represent image pixels of the image. In some examples, the array of pixels is provided 430 as an array of adjacent regions of an electrode, each region representing one of the pixels of the array. Each region is further divided into sub-regions representing the subpixels. In these examples, designating 420 the selected subpixels may comprise patterning the electrode, for example.

In some examples, patterning the electrode may comprise providing a conductor within only the sub-regions of the selected set of subpixels. As such, the non-selected sub-regions are absent the conductor. The provided conductor of each sub-region may be electrically connected to an edge of the pixel either directly or through the conductor of adjacent sub-regions, according to some examples. In other examples, wherein the electrode comprises a conductor covered by a dielectric layer, patterning the electrode comprises providing an opening in the dielectric layer to expose the conductor within the sub-region of the selected set of subpixels. Patterning may be performed using one or more of laser ablation, etching, conductor printing, and other circuit fabrication methodologies.

In some examples, the method 400 of displaying an image further comprises applying 440 an electrical signal to energize the selected 410 and designated 420 subpixels of the set. The electrical signal may be applied 440 to the conductor of the electrode, for example. In some examples, the electrical signal may include, but is not limited to, a voltage and a current. The voltage may be communicated among all of the selected 410 and designated 420 subpixels of the set by virtue of an interconnection between those subpixels, for example. In some examples, energizing the selected 410 and designated 420 subpixels may cause the subpixels to assume a second state and exhibit the minimum intensity (or the maximum intensity) while the subpixels that are not selected are not energized by the electrical signal and remain in a first state exhibiting the maximum intensity (or the minimum intensity, i.e., the other intensity), for example.

Thus, there have been described examples of a static electronic display and a method of displaying an image that employ pixels having subpixels that exhibit one of a minimum intensity and a maximum intensity of an intensity range of the image. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A static electronic display comprising:
an array of pixels of an electrode patterned to represent corresponding image pixels of an image, each pixel of the array comprising a plurality of subpixels, each subpixel in the plurality to exhibit one of a minimum intensity and a maximum intensity of an intensity range of the image pixels,
wherein a relative number of the minimum intensity subpixels and the maximum intensity subpixels of each pixel in the array corresponds to an intensity level of a corresponding image pixel of the image.

2. The static electronic display of claim 1, wherein the image is a grayscale image, the intensity range being a grayscale range, and wherein the minimum intensity represents a grayscale level substantially at a first end of the grayscale range, the maximum intensity representing a grayscale level substantially at a second end of the grayscale range, the second end being opposite the first end.

3. The static electronic display of claim 1, wherein a number of subpixels in a pixel of the electrode is equal in number to an integer multiple of a total number of intensity levels of the intensity range.

4. The static electronic display of claim 3, wherein the intensity range begins at a numerical value of zero corresponding to a respective one of the minimum intensity and the maximum intensity, and wherein a number of subpixels in each pixel of the respective minimum intensity or maximum intensity equals the integer multiple of a numerical value of the intensity level of the corresponding image pixel.

5. The static electronic display of claim 1, wherein, for each subpixel not adjacent to an edge of the pixel, there is an unbroken path from either each minimum intensity subpixel or each maximum intensity subpixel to the edge of the pixel.

6. The static electronic display of claim 1, wherein an arrangement of the minimum intensity subpixels and the maximum intensity subpixels is substantially random within the pixel, the random arrangement comprising either each minimum intensity subpixel or each maximum intensity subpixel having an unbroken path to an edge of the pixel through contiguous subpixels of the respective intensity.

7. The static electronic display of claim 1, wherein an arrangement of the minimum intensity subpixels and the maximum intensity subpixels within the pixel is based on one of a spiral pattern, a diagonal pattern, and a linear pattern within the pixel.

8. The static electronic display of claim 1, wherein the electrode comprises a conductor patterned within a region of each pixel of the array to provide sub-regions corresponding to a first set of subpixels in which the conductor is absent and to provide other sub-regions corresponding to a second set of subpixels in which the conductor is present, the first set representing one of the maximum intensity subpixels and the minimum intensity subpixels, and wherein each subpixel of the second set is either directly or indirectly electrically connected to an edge of the pixel region of the electrode, the indirect electrical connection being through adjacent conductor-present subpixels.

9. The static electronic display of claim 1, wherein the electrode comprises a conductor covered by a dielectric layer patterned to provide both sub-regions corresponding to a first set of subpixels in which the dielectric layer is absent to substantially expose the conductor and sub-regions corresponding to a second set of subpixels in which the dielectric layer is present, the first set representing one of the minimum intensity subpixels and the maximum intensity subpixels.

10. A static electronic display comprising:
a first electrode patterned with pixels to represent corresponding pixels of an image, each pixel comprising a plurality of patterned subpixels, each patterned subpixel in the plurality to exhibit one of a minimum intensity and a maximum intensity of an intensity range of the image;
a second electrode positioned in opposition to the first electrode; and
a display medium between the first electrode and the second electrode,
wherein a relative number of the maximum intensity patterned subpixels and the minimum intensity patterned subpixels corresponds to an intensity level of a corresponding image pixel of the image.

11. The static electronic display claim 10, wherein a number of patterned subpixels in a pixel of the first electrode is equal in number to an integer multiple of a total number of intensity levels of the intensity range.

12. The static electronic display of claim 10, wherein the patterned first electrode comprises a conductor patterned within a region of each pixel to provide sub-regions corresponding to a first set of subpixels in which the conductor is absent and to provide sub-regions corresponding to a second set of subpixels in which the conductor is present, the first set representing one of the maximum intensity subpixels and the minimum intensity subpixels, and wherein each of the conductor-present sub-regions of the second set is electrically connected to an edge of the region of the patterned first electrode representing the pixel.

13. The static electronic display of claim 10, wherein the patterned first electrode comprises a conductor covered by a dielectric layer that is patterned to provide sub-regions corresponding to a first set of subpixels in which the dielectric layer is absent to expose the conductor and to provide sub-regions corresponding to a second set of subpixels in which the dielectric layer is present, the dielectric layer being on a side of the patterned first electrode adjacent to the second electrode and in contact with the display medium, and wherein the first set represents one of the minimum intensity subpixels and the maximum intensity subpixels.

14. The static electronic display of claim 10, wherein the first electrode comprises a substantially transparent conductor material and the display medium comprises charged colorant particles suspended in a carrier liquid.

15. The static electronic display of claim 10, wherein the image is a color image, and wherein the plurality of patterned subpixels is divided into subsets of the patterned subpixels, each subset representing a color channel of the color image, and wherein the maximum intensity, the minimum intensity and the intensity range within each subset are determined according to a color of the represented color channel.

16. A method of displaying an image, the method comprising:
selecting a set of subpixels from a plurality of subpixels in each pixel of an array of pixels, the pixels in the array to represent image pixels of an image, wherein a quantity of subpixels in the selected set of each pixel corresponds to an intensity level of a corresponding image pixel of the image; and
designating subpixels of the selected set to exhibit one of a minimum intensity and a maximum intensity of an intensity range of the image,
wherein remaining subpixels of the plurality that are not selected in each pixel exhibit the other of the maximum intensity and the minimum intensity of the intensity range.

17. The method of displaying an image of claim 16, further comprising providing the array of pixels as an array of adjacent regions of an electrode, each region representing one of the pixels of the array and being divided into sub-regions representing the subpixels, and wherein designating the selected set of subpixels comprises patterning the electrode.

18. The method of displaying an image of claim 17, wherein patterning the electrode comprises providing a conductor within the sub-regions of the selected set of subpixels, the conductor being absent in the sub-regions of the subpixels that are not selected, the provided conductor of each sub-region of the selected set being electrically connected to an edge of the pixel either directly or indirectly through the conductor of adjacent sub-regions of the selected set.

19. The method of displaying an image of claim 17, wherein the electrode comprises a conductor covered by a dielectric layer, and wherein patterning the electrode comprises providing an opening in the dielectric layer to expose the conductor within each sub-region of the selected set of subpixels.

20. The method of displaying an image of claim 16, further comprising applying an electrical signal to an electrode to energize the selected and designated set of subpixels, wherein energizing causes the subpixels of the set to assume a second state and exhibit the one of the minimum intensity and the maximum intensity, and wherein the remaining subpixels that are not selected are not energized by the electrical signal, the nonselected subpixels persist in a first state exhibiting the other of the maximum intensity and the minimum intensity.
